(19) United States
(12) Patent Application Publication
(10) Pub. No.: US 2015/0120566 A1
(43) Pub. Date: Apr. 30, 2015

(54) System and Method for Digital Media Rights Management

(71) Applicant: Brahim OUMALEK, Malden, MA (US)

(72) Inventor: Brahim OUMALEK, Malden, MA (US)

(21) Appl. No.: 14/065,167

(22) Filed: Oct. 28, 2013

(51) Int. Cl. G06Q 50/18; G06Q 10/00

(52) U.S. Cl. CPC G06Q 50/184; G06Q 10/00
USPC 705/51

(57) ABSTRACT

A method for digital rights management uniquely associates a user with their digital media player, and encrypts a digital media file upon sale of the media so that the media cannot be decrypted and played by any media player but the one associated with the user.

### FIELD OF THE INVENTION

The present invention relates generally to media. More particularly, the present invention relates to digital rights management.

### BACKGROUND OF THE INVENTION

Digital rights management (DRM) is a class of technologies that are used by hardware manufacturers, publishers, copyright holders, and individuals with the intent to control the use of digital content and devices after sale. DRM is also sometimes referred to as copy protection, copy prevention, and copy control. In essence, DRM is a set of access control technologies.

In the past, media such as movies and music has been limited to one copy of the media per physical device to carry it, such as a movie on a VHS tape, or music on a vinyl record. This served to facilitate personal ownership of individual copies of the media, so that if multiple people wished to own a copy of a certain media, each person had to have their own copy. This made the flow path from production to ownership in regards to making a profit from the media simple, as each person who wished to consume the media must purchase a copy for their own, or borrow a copy from a friend, who then is faced with a lack of the media copy.

In the digital age, however, limitless copies of files may be made as long as there is sufficient digital storage available. This leads to losses by production companies, as multiple people may gain access to the media with only one person actually paying for it.

It is therefore an object of the present invention to provide a method for implementing a system that guarantees that only the customer who purchases media such as a movie can utilize the media, and that guarantees that the media cannot be copied and redistributed for free.

### BRIEF DESCRIPTION OF THE DRAWINGS

FIG. 1 is a stepwise flow diagram describing the overall process of the present invention, wherein references (A), (B), (C), (D), (E), (F), (G), (H), (I), (J), (K), and (L) represent the individual steps of the overall process.

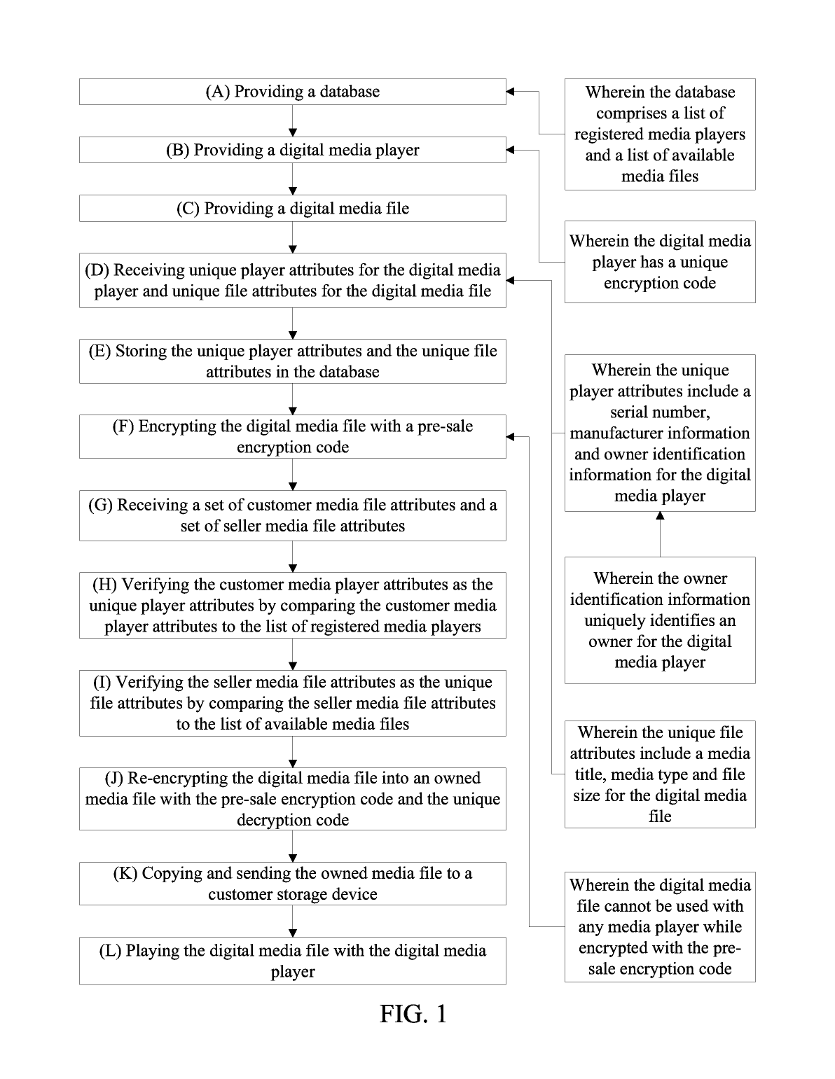

FIG. 2 is a stepwise flow diagram describing a process for rejecting a media transaction, wherein references (A), (B), (C), (D), (E), (F), (G), (H), (I), (J), (K), and (L) represent the individual steps of the overall process.

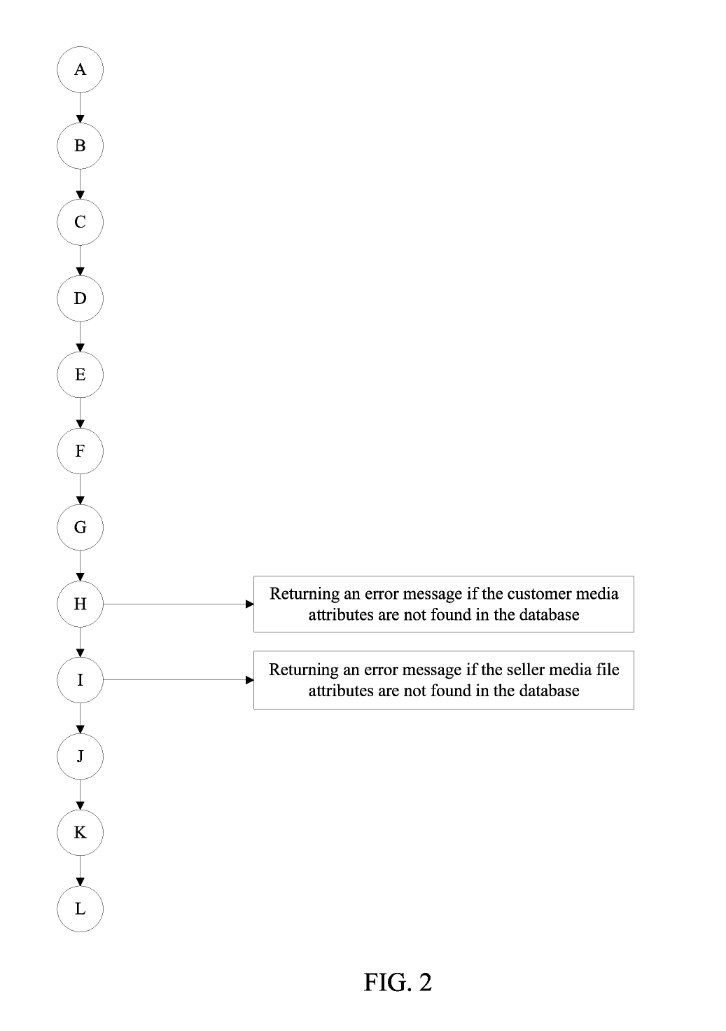

FIG. 3 is a stepwise flow diagram describing the re-encryption process after validating a media transaction, wherein references (A), (B), (C), (D), (E), (F), (G), (H), (I), (J), (K), and (L) represent the individual steps of the overall process.

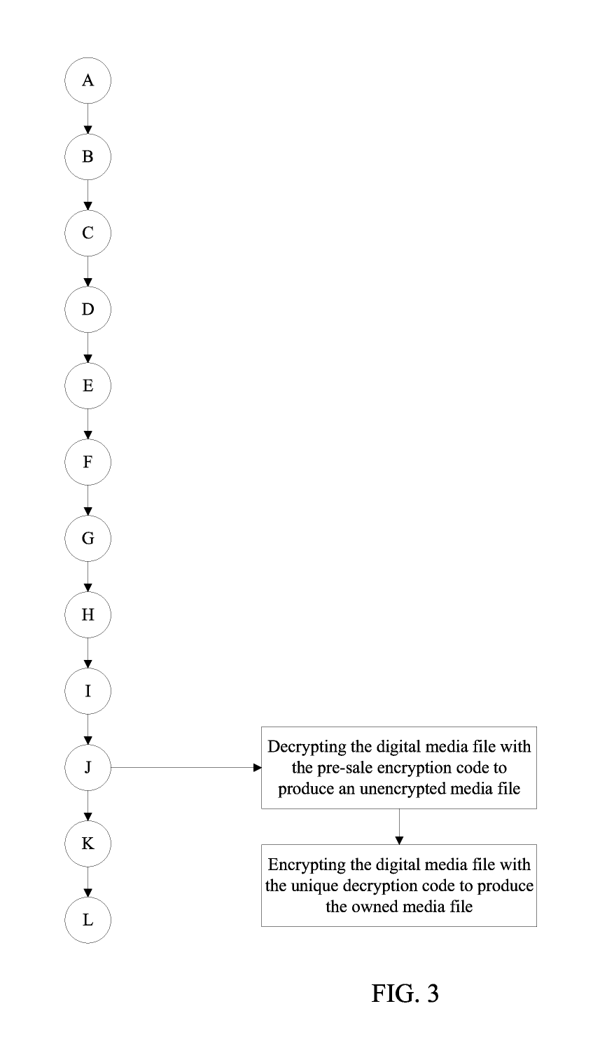

FIG. 4 is a stepwise flow diagram describing processes for playing the digital media file, wherein references (A), (B), (C), (D), (E), (F), (G), (H), (I), (J), (K), and (L) represent the individual steps of the overall process.

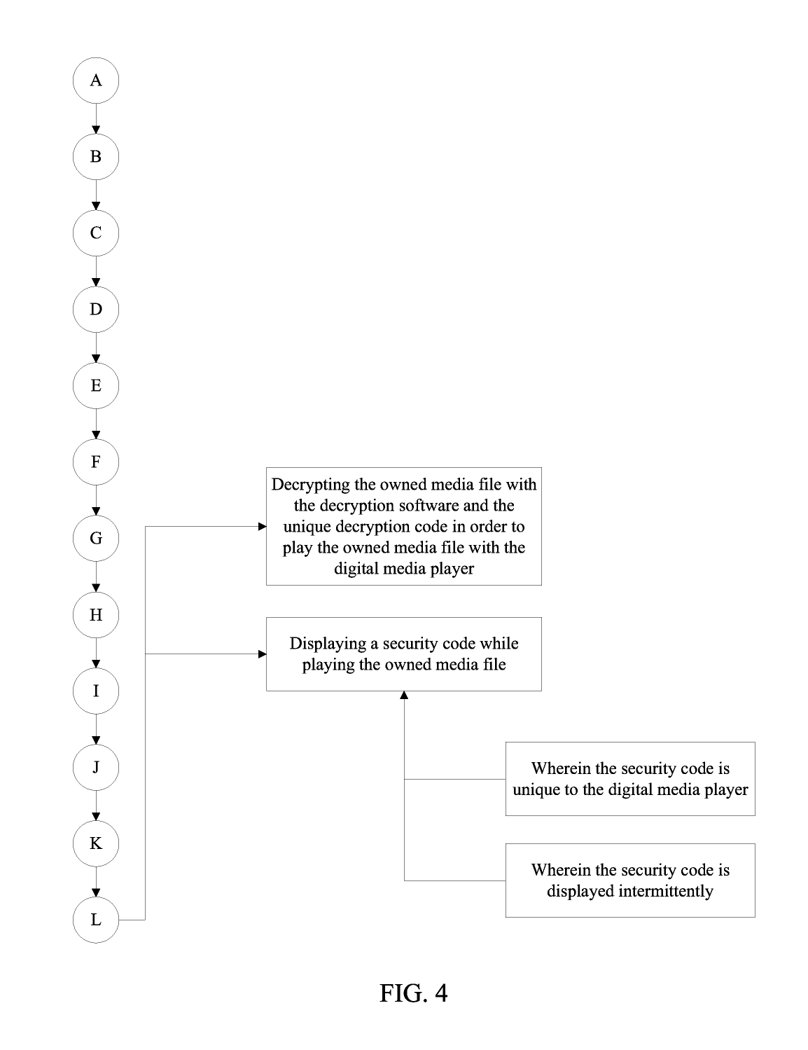

### DETAIL DESCRIPTIONS OF THE INVENTION

All illustrations of the drawings are for the purpose of describing selected versions of the present invention and are not intended to limit the scope of the present invention.

The present invention is a method for implementing a system wherein a digital media file is sold and restricted for sole use by the user who bought the digital media file. Use of the digital media file is restricted to the user by encrypting the digital media file, which can only be decrypted by a digital media player owned by the user which possesses the correct decryption software. The user is uniquely associated with both the digital media player and the digital media file, so that any attempts at piracy may be traced back to the user for punishment of copyright infringement. In the preferred embodiment of the present invention, the digital media file is a video such as, but not limited to, a movie, a television show, a documentary, or another type of video. However, it is contemplated that in alternate embodiments the digital media file may be other types of digital media, such as, but not limited to, an audio file such as music or a podcast, or a picture.

The present invention is preferably embodied as a system of hardware and software components. A server sends, receives and processes various commands in order to implement the present invention. Users interact with the server through software applications on personal computers that are connected to the server through digital network connections. The software is also responsible for encryption of the digital media file. The specific method of encryption is not of particular importance to the present invention. However, in the preferred embodiment, the software encrypts and decrypts the digital media file by rearranging certain bytes in the digital media file according to an encryption or decryption code.

In the process of the present invention, a database (A), a digital media player (B), and a digital media file are provided (C). The database includes information relevant to the present invention, such as, but not limited to, a list of available media files and a list of registered media players, wherein the digital media file is one of the available media files and the digital media player is one of the registered media players. In the preferred embodiment of the present invention, the digital media player is assumed to be a digital video disc (DVD) player, but the digital media player may also be embodied as any other hardware that is capable of facilitating consumption of digital media, such as, but not limited to, a smart television, a personal computer, or a video game console.

The digital media player has unique player attributes, a unique decryption code, and media decryption software. The unique player attributes preferably include information such as, but not limited to, a serial number and manufacturer information for the digital media player. The unique player attributes may also include other information such as the type of digital media player, brand, or other identifying information. The unique player attributes uniquely identify the digital media player. In the preferred embodiment of the present invention, the unique decryption code and the media decryption software are present in the operating software of the digital media player from the manufacturer, but in an alternate embodiment the unique decryption code and the media decryption software may be installed on the digital media player as an add-on from a third party, or as a software update or upgrade from the manufacturer or production company of the digital media player.

The digital media file has unique file attributes which uniquely identify the digital media file. Preferably, the unique file attributes include, but are not limited to, a media title, media type, file size, and media producer.

After the digital media player has been manufactured, the manufacturer registers the digital media player with the database. The manufacturer sends the unique player attributes to the server, which are received (D) and stored in the database (E). A user then purchases the digital media player. Upon purchase of the digital media player, owner identification information such as, but not limited to, home address, driver's license number or social security number, is collected from the user and added to the unique player attributes in the database. Therefore, the owner identification information uniquely identifies the user as the owner of the digital media player.

After the digital media file is produced, the unique file attributes are received by the server and stored in the database. Then the digital media file is encrypted with a pre-sale encryption code (F). The pre-sale encryption code encrypts the digital media file so that the digital media file cannot be used with any media player without being decrypted. Once the digital media file is in the possession of a media seller, the pre-sale encryption code prevents the seller from distributing the digital media file for use to anyone but a paying customer.

At a point of sale where a customer wishes to purchase the digital media file from a seller, the customer gives the seller a set of customer media player attributes, which the seller inputs into the software and is received by the server (G). The seller additionally inputs a set of seller media file attributes into the software, which are received by the server. The set of customer media player attributes and the set of seller media file attributes are as yet unknown and must be verified in order to verify a transaction in which the customer purchases the digital media file. The customer media player attributes are verified by comparing the customer media player attributes to the list of registered media players in the database (H), wherein the customer is the owner of the digital media player, and wherein the customer media player attributes are verified as the unique player attributes. Similarly, the seller media file attributes are verified as the unique file attributes by comparing the seller media file attributes to the list of available media files (I). Once the digital media player is found in the database, the unique encryption code is retrieved. If the customer media player attributes are not found in the database, or if the seller media file attributes are not found in the database, an error message is returned and the transaction is not verified. It should be noted that “customer” and “user” are used interchangeably herein.

After the transaction is verified, the digital media file is re-encrypted into an owned media file with the pre-sale encryption code and the unique decryption code (J). To accomplish this, the digital media file is processed by the software. The software decrypts the digital media with the pre-sale encryption code to produce an unencrypted media file, and subsequently encrypts the unencrypted media file with the unique decryption code to produce the owned media file.

The owned media file is then copied and sent to a customer storage device provided by the customer (K). The customer storage device may be any digital storage device which is capable of storing the owned media file, such as, but not limited to, a compact disc (CD), a DVD, a flash memory stick, a hard disk drive (HDD), or another storage device. The user may then access the customer storage device with the digital media player in order to play the owned media file with the digital media player (L). It is contemplated that the owned media file may also be transferred to internal storage on the digital media player so that the customer storage device is not necessary for further consumption of the owned media file. The owned media file is decrypted by the digital media player with the decryption software and the unique decryption code in order to play the owned media file with the digital media player.

The preferred embodiment of the present invention comprises the following additional security feature. When the digital media file is played with the digital media player on a viewing screen, a security code is displayed on the viewing screen. Preferably, the security code is displayed intermittently. Furthermore, the security code should appear in random locations or in a predefined or generated pattern around the viewing screen, and should only be displayed for a very short time such as, but not limited to, a single frame or one millisecond in each location. This is so that the security code is not visible to the user while playing the digital media file and does not disrupt the user's viewing experience.

The security code is unique to the digital media player, and is part of the unique player attributes stored in the database. The security code serves as a watermark and is an anti-piracy measure. If the user or another person attempts to reproduce the content of the digital media file by recording the viewing screen while the digital media file is being played, or by utilizing another video capture device, the security code will be shown on the resulting pirated media file. Since the security code is uniquely associated with the digital media player, and since the digital media player is uniquely associated with the user, the pirated media file can be traced back to the user so that the user can be prosecuted for copyright infringement. Preferably, in order to account for varying frame rates of media files and media capture devices, multiple instances of the security code are simultaneously implemented in multiple locations across the viewing screen and at varying frequencies. This prevents a would-be media pirate from capturing the media at a frame rate which would skip capture of frames displaying the security code.

A further additional feature of the present invention accounts for a situation in which the digital media player is lost, stolen or damaged. In this case, the user should go to a media seller utilizing the present invention and provide the unique player attributes so that the digital media player can be marked as invalid in the database. To further use the media, the user must purchase a new media player and repeat the process of encrypting the digital media file for use with the new media player. If the person who stole the digital media player attempts to utilize the digital media player with the present invention, the transaction will not be allowed to be processed since when the unique player attributes are provided, the software will recognize that the digital media player has been marked as invalid and cannot be used.

Although the invention has been explained in relation to its preferred embodiment, it is to be understood that many other possible modifications and variations can be made without departing from the spirit and scope of the invention as hereinafter claimed.

1. A method for implementing a digital movie protection system by executing computer-executable instructions stored on a non-transitory computer-readable medium comprises the steps of:
providing a database, wherein the database includes a list of available media files and a list of registered media players;
providing a digital media player,
wherein the digital media player has unique player attributes, a unique decryption code, and media decryption software;
wherein the unique player attributes uniquely identify the digital media player;
providing a digital media file,
wherein the digital media file has unique file attributes;
wherein the unique file attributes uniquely identify the digital media file;
receiving the unique player attributes, wherein the unique player attributes include owner identification information;
receiving the unique file attributes;
storing the unique player attributes and the unique file attributes in the database;
encrypting the digital media file with a pre-sale encryption code;
receiving a set of customer media player attributes, wherein the customer media player attributes are received from a customer at a media sale point;
receiving a set of seller media file attributes, wherein the seller media file attributes are received from a seller at the media sale point;
verifying the customer media player attributes as the unique player attributes by comparing the customer media player attributes to the list of registered media players;
verifying the seller media file attributes as the unique file attributes by comparing the seller media file attributes to the list of available media files;
re-encrypting the digital media file into an owned media file with the pre-sale encryption code and the unique decryption code;
copying and sending the owned media file to a customer storage device;
playing the digital media file with the digital media player;
displaying a security code while playing the owned media file, wherein the security code is unique to the digital media player, and the security code is displayed intermittently;
wherein the digital media file cannot be used with any media player while encrypted with the pre-sale encryption code; and
wherein the owner identification information uniquely identifies an owner for the digital media player.

2. The method for implementing a digital movie protection system by executing computer-executable instructions stored on a non-transitory computer-readable medium as claimed in claim 1 comprises the steps of:
decrypting the digital media file with the pre-sale encryption code to produce an unencrypted media file; and
encrypting the unencrypted media file with the unique decryption code to produce the owned media file.

3. The method for implementing a digital movie protection system by executing computer-executable instructions stored on a non-transitory computer-readable medium as claimed in claim 1 comprises the steps of:
returning an error message,
if the customer media player attributes are not found in the database, or
if the seller media file attributes are not found in the database.

4. The method for implementing a digital movie protection system by executing computer-executable instructions stored on a non-transitory computer-readable medium as claimed in claim 1 comprises the step of:
decrypting the owned media file with the decryption software and the unique decryption code in order to play the owned media file with the digital media player.

5. The method for implementing a digital movie protection system by executing computer-executable instructions stored on a non-transitory computer-readable medium as claimed in claim 1, wherein the unique player attributes include a serial number and manufacturer information for the digital media player.

6. The method for implementing a digital movie protection system by executing computer-executable instructions stored on a non-transitory computer-readable medium as claimed in claim 1, wherein the unique file attributes include a media title, media type and file size for the digital media file.

7. (canceled)

8. (canceled)

9. (canceled)

10. (canceled)
